(19) United States
(12) Patent Application Publication
(10) Pub. No.: US 2015/0085100 A1
(43) Pub. Date: Mar. 26, 2015

(54) SYSTEM FOR DETECTION OF ANIMALS AND PESTS

(71) Applicants: Micholas Raschella, Buckhannon, WV (US); Michael Masterman, Philippi, WV (US)

(72) Inventors: Micholas Raschella, Buckhannon, WV (US); Michael Masterman, Philippi, WV (US)

(21) Appl. No.: 14/468,915

(22) Filed: Aug. 26, 2014

Related U.S. Application Data
(60) Provisional application No. 61/882,749, filed on Sep. 26, 2013.

(51) Int. Cl. H04N 7/18

(52) U.S. Cl. CPC H04N 7/188
USPC 348/82

(57) ABSTRACT

An pest detector includes an atrium at least one tunnel that funnels the pest into the atrium. The pest detector further includes at least one sensor pointed at the atrium or the tunnel. The pest detector further includes a camera pointed at the atrium that photographs an pest when the pest is detected by the at least one sensor. The pest detector further includes a communicator that sends a notification if an pest is detected by the at least one sensor.

### TECHNICAL FIELD

The apparatus described herein relates to the field of pest control, more particularly, to the field of infestation detection.

### BACKGROUND

There has been considerable increase in bug infestations in recent years. These infestations often spiral out of control because the insects are not seen until there is a large number of them, and by this time they have become so colonized that they are difficult to remove and/or exterminate. Early and immediate detection of insects would enable their extermination before they begin to colonize or become invasive. As such, the early detection of insects would save time and money for the owners of large facilities such as hotels.

All other insect detection devices require a person to physically look into the device to determine the presence or absence of insects. This is time consuming, costly, and leaves room for human error. Moreover, some locations are more difficult to access on a normal basis. For example, occupied motel rooms are usually not checked for insects because it is annoying and off-putting for the guests. In another example, usually areas behind walls or under floorboards are not checked because the building must be damaged in order to access those areas. Therefore, the insects are given an opportunity to take hold in areas of a building not accessed by humans before they are even noticed in occupied areas.

There is a need in the art for a way to detect pest infestations early and without regular human inspection.

### BRIEF SUMMARY

An pest detector includes an atrium at least one tunnel that funnels the pest into the atrium. The pest detector further includes at least one sensor pointed at the atrium or the tunnel. The pest detector further includes a camera pointed at the atrium that photographs an pest when the pest is detected by the at least one sensor. The pest detector further includes a communicator that sends a notification if an pest is detected by the at least one sensor.

In some embodiments, the pest detector further includes an attractant releaser that releases an attractant into the atrium. In some embodiments, the attractant releaser includes a micro valve in fluid communication with an attractant reservoir. In some embodiments, the attractant releaser is a CO2 generator. In some embodiments, the pest is a colonizing animal. In some embodiments, the pest is an insect. In some embodiments, the at least one tunnel is four triangular tunnels in a square arrangement that lead to four entryways into the atrium. In some embodiments, the four triangular tunnels are formed by four walls extending from corners of the atrium. In some embodiments, the at least one sensor is four sensors each located at an entryway to the atrium. In some embodiments, the notification includes at least one photograph taken by the camera. In some embodiments, the pest detector further includes an insect identifier that identifies an insect photographed by the camera, and the notification includes an identity of the insect identified by the insect identifier. In some embodiments, the camera and the at least one sensor are located on a lid above the atrium. In some embodiments, the pest detector further includes at least one UV light emitter that emits UV light into the atrium or the at least one tunnel, and the at least one sensor is a UV light sensor and senses when an insect blocks a reflection or direct incidence of the UV light. In some embodiments, the pest detector further includes a visible light emitter that emits visible light into the atrium that illuminates photographs taken by the camera.

### BRIEF DESCRIPTION OF THE DRAWINGS

FIG. 1: is a perspective view of one embodiment of the apparatus.

FIG. 2: is top perspective exploded view of the embodiment of FIG. 1.

FIG. 3: is bottom perspective exploded view of the embodiment of FIG.

FIG. 4: is top perspective view of the electronics 10 of the embodiment of FIG. 1.

FIG. 5: is bottom perspective view of the electronics 10 of the embodiment of FIG. 1.

FIG. 6: is section view of the embodiment of FIG. 1 along line 6-6 in FIG. 1.

FIG. 7: is block diagram of the embodiment of FIG. 1.

### DETAILED DESCRIPTION

The system is composed of an electrical system and a mechanical system. The mechanical system is formed from plastic in some embodiments with rough floor that allow an insect to crawl into and towards the attractant at the center. Suspended above the floor 20 is an electronics package or printed circuit board that provides the other four elements, processing, entry detection, imaging, and communication.

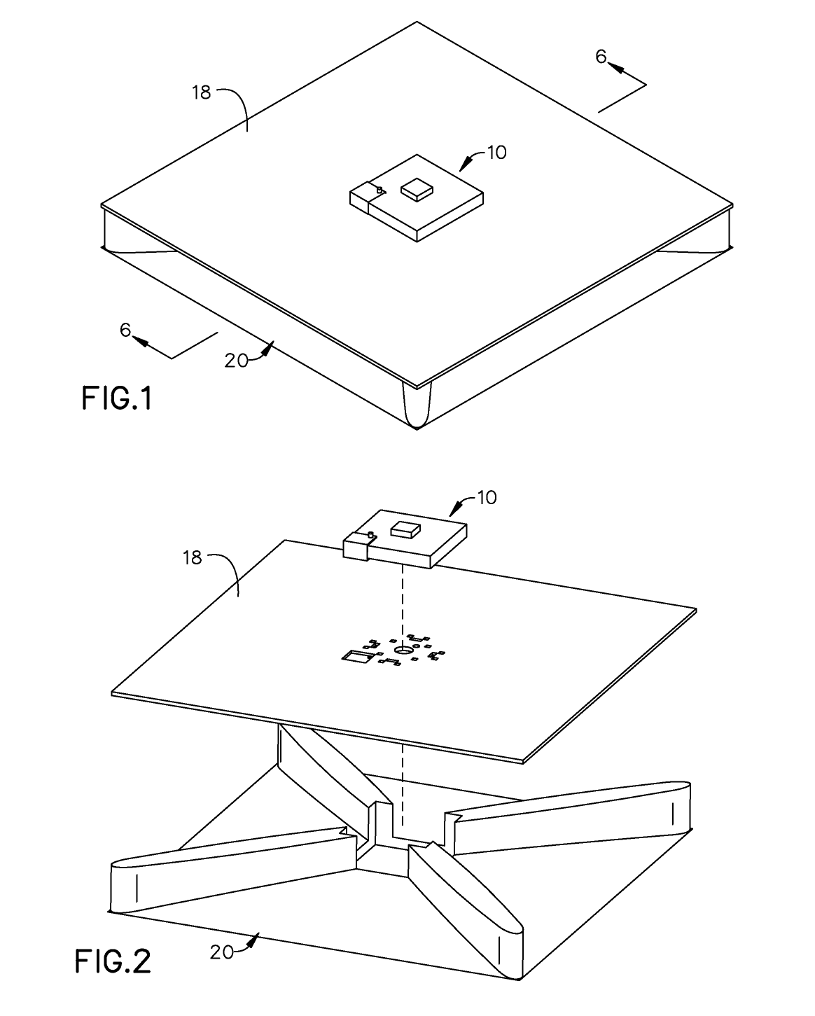

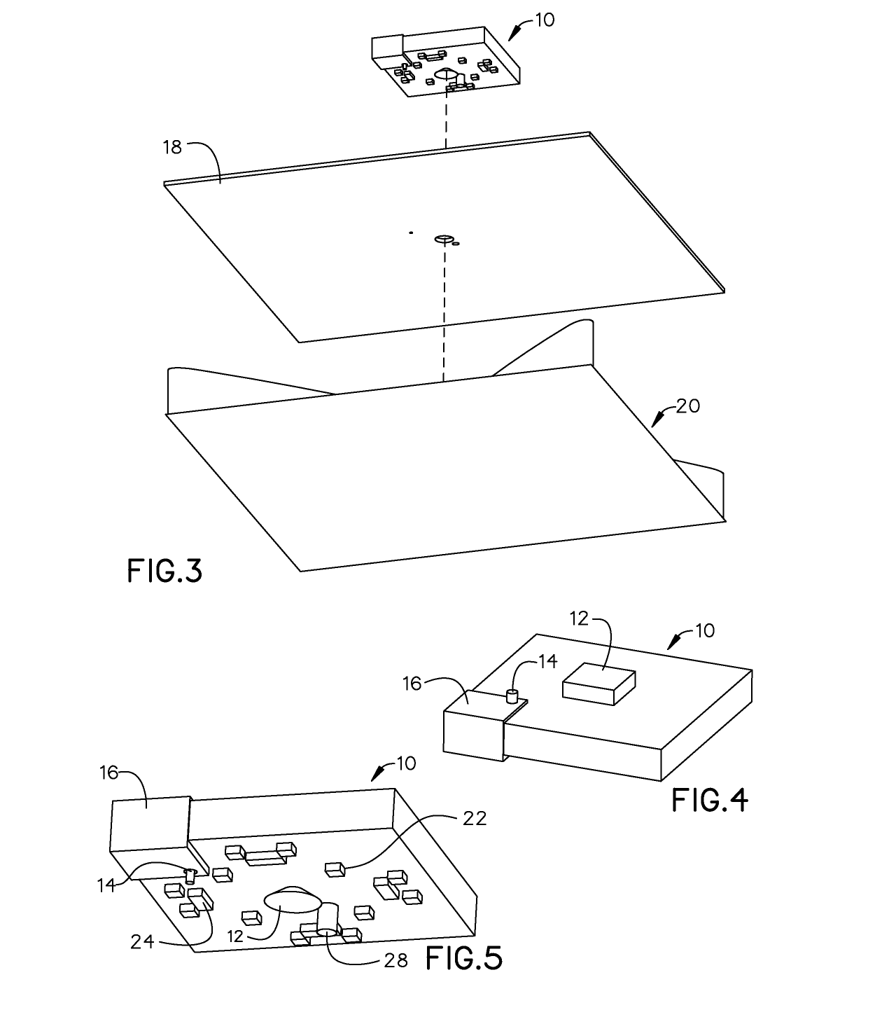

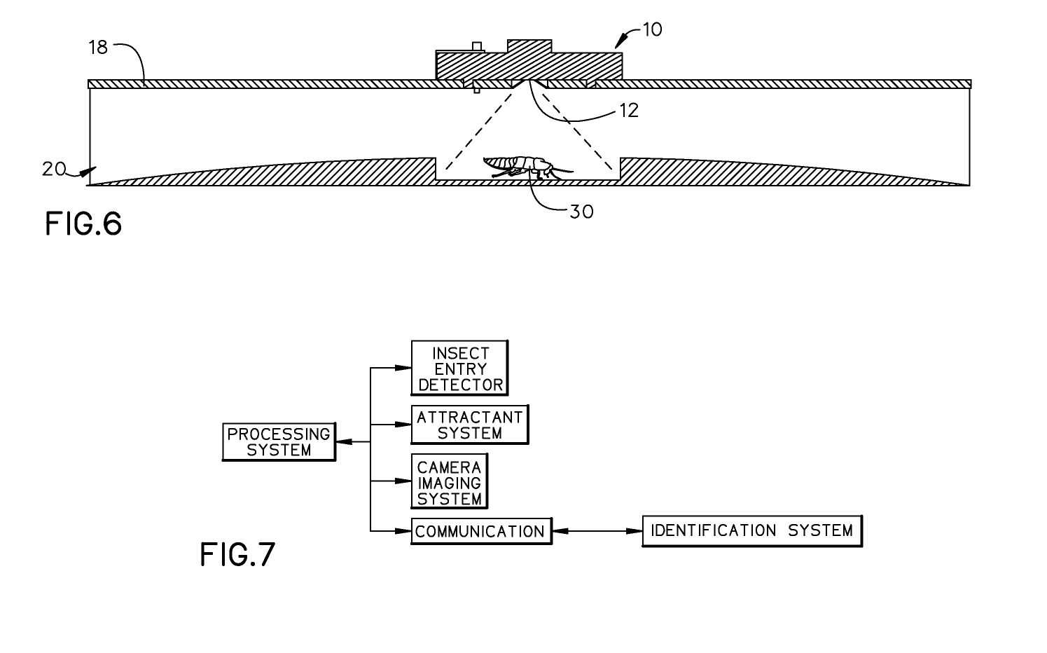

FIGS. 1-3 and 6 show one embodiment of the system. The system comprises a walkway that funnels pests (in these embodiments, insects) into an area within range of a camera 12. The walkway comprises a base 20 and a lid 18. Electronics 10 are coupled to lid 18 and comprises insect detection and communication equipment. As can be seen from the drawings, base 20 comprises walls in an “X” pattern that funnel all insect 30 traffic through an atrium in the center, which is within range of camera 12. Therefore, all insect 30 traffic through a relatively large area will be forced to walk under camera 12 and will be detected and reported to an exterminator or business manager in a remote location.

FIGS. 4 and 5 show detailed views of electronics 10. Electronics 10 comprises a linear threshold detector 24. This detector 24 detects when an insect 30 has entered the range of camera 12. Camera 12 and solid-state lighting 22 are then triggered to take a flash photograph of insect 30. In this embodiment, electronics 10 has four detectors 24, one at each entryway to the atrium. The microprocessor is programmed to recognize the response from the entry detector and turns on the camera imaging system which takes photos of the insect 30 around the attractant. The processor (or logic system) takes this photo and sends it through the communication system which is built from WIFI radio, Bluetooth or other standard protocol.

The entry detector 24 utilizes different technologies to indicate when an insect 30 has crossed the threshold in moving towards the attractant. An example of this, if the plastic structure is black, a UV Light shines sideways and as the insect 30 travels through, the UV light is reflected off the insect 30 and detected by light detecting diodes 24 above the insect 30. The UV light may be generated by solid state lighting 22.

Electronics 10 also includes attractant systems that will lure insects 30 into the device. These include an attractant reservoir 16 that stores attractant, and a micro valve 14 that releases attractant in a controlled manner into the chamber. Electronics 10 also includes a CO2 generator 28, which also attracts insects 30. The attractant system can utilize many different approaches to attract the insects, including pheromones, gas discharge, food source replication, and heat.

Once insect 30 has been photographed, the electronics 10 will send the photograph to a remote location using wired or wireless communication. Once an intended recipient who is monitoring for pests receives the photograph, they will be able to identify insect 30—in some embodiments with the aid of a computerized identification system. The identification system of the insect is composed of either a human assisted system or machine vision software programmed to perform comparison and alert people to the type of insect. If the identification system is integrated in electronics 10, then when the system communicates information, it could send text information as to the species of insect it has detected.

FIG. 7 contains a block diagram of the system. This embodiment comprises a processing system in communication with an insect entry detector, attractant system, camera imaging system, and communication/identification systems.

This system can be placed discretely under the beds at motel rooms, when the first bedbug is brought into the room from a traveler, the system detects an insect 30, sends the photo to an exterminator and if the image is that of a bedbug the exterminator is deployed to eradicate the bedbugs early on and prevent a large infestation problems.

The system can also be placed in a cabinet or under a sink, as certain insects start to surround the attractant, an extermination company can be notified of the insects and called in quickly to remedy the problem before it becomes an issue with health inspectors.

The system could also be permanently installed in an area that cannot be accessed again. For example, it could be installed under the floor-boards, inside walls, inside ventilation systems, inside sewer systems, subway tunnels, etc . . . This would allow for ready detection of insects in areas inaccessible to people.

This system could also be used in the detection of small mammals such as mice or bats, using it for detection of pests or in counting for research purposes. It could also be used in the detection of fish swimming through a small channel, being able to count the fish and classify them.

Although the invention has been described with reference to embodiments herein, those embodiments do not limit the invention. Modifications to those embodiments or other embodiments may fall within the scope of the invention.

What is claimed is:

1. An pest detector, comprising:
an atrium;
at least one tunnel that funnels the pest into said atrium;
at least one sensor pointed at said atrium or said tunnel;
a camera pointed at said atrium that photographs an pest when the pest is detected by said at least one sensor; and
a communicator that sends a notification if an pest is detected by said at least one sensor.

2. The pest detector of claim 1, further comprising:
an attractant releaser that releases an attractant into said atrium.

3. The pest detector of claim 2, wherein said attractant releaser includes a micro valve in fluid communication with an attractant reservoir.

4. The pest detector of claim 2, wherein said attractant releaser is a CO2 generator.

5. The pest detector of claim 1, wherein the pest is a colonizing animal.

6. The pest detector of claim 1, wherein the pest is an insect.

7. The pest detector of claim 1, wherein said at least one tunnel is four triangular tunnels in a square arrangement that lead to four entryways into said atrium.

8. The pest detector of claim 7, wherein the four triangular tunnels are formed by four walls extending from corners of said atrium.

9. The pest detector of claim 7, said at least one sensor is four sensors each located at an entryway to said atrium.

10. The pest detector of claim 1, wherein the notification includes at least one photograph taken by said camera.

11. The pest detector of claim 1, further comprising:
an insect identifier that identifies an insect photographed by said camera;
wherein the notification includes an identity of the insect identified by said insect identifier.

12. The pest detector of claim 1, wherein said camera and said at least one sensor are located on a lid above said atrium.

13. The pest detector of claim 1, further comprising:
at least one UV light emitter that emits UV light into said atrium or said at least one tunnel;
wherein said at least one sensor is a UV light sensor and senses when an insect blocks a reflection or direct incidence of the UV light.

14. The pest detector of claim 1, further comprising:
a visible light emitter that emits visible light into said atrium that illuminates photographs taken by said camera.
